(19) United States
(12) Patent Application Publication
(10) Pub. No.: US 2005/0198777 A1
(43) Pub. Date: Sep. 15, 2005

(54) Hinge apparatus with two-way controllable shape memory alloy (SMA) hinge pin actuator and methods of making two-way SMA parts

(76) Inventor: James H. Mabe, Seattle, WA (US)

Correspondence Address: HARNESS, DICKEY & PIERCE, P.L.C., P.O. BOX 828, BLOOMFIELD HILLS, MI, 48303, US

(21) Appl. No.: 10/796,806

(22) Filed: Mar. 9, 2004

(51) Int. Cl. E05F 1/08

(52) U.S. Cl. 16/308

(57) ABSTRACT

A hinge apparatus generally includes a hinge pin formed of a two-way shape memory alloy (SMA) adapted to transition, without an externally applied load, between a first trained shape and a second trained shape upon switching the two-way SMA between a first state and a second state. The hinge pin can apply two-way reversible actuation forces to a device coupled to the hinge apparatus. The hinge pin can be produced by thermal cycling a material under a sufficient load for a sufficient number of thermal cycles between about the material's austenite and martensite temperatures to complete training of the material. The thermal cycling conditions the material to transition, without an externally applied load, between an austenitic shape and a martensitic shape to perform useful work when the material is thermally cycled between the austenite and martensite temperatures.

### NOTICE OF GOVERNMENT RIGHTS

The invention described herein was conceived and/or reduced to practice at least in part pursuant to U.S. Government Contract No. N00421-99-D-1191 DO 00005. The U.S. Government has certain rights in this invention.

### FIELD

The present invention generally relates to shape memory alloys (SMA). More particularly (but not exclusively), the present invention relates to methods of making two-way SMA parts and to hinge apparatus that include a two-way controllable hinge pin actuator formed from a two-way SMA.

### BACKGROUND

Shape memory alloys (SMA) form a group of metals that have interesting thermal and mechanical properties. If a SMA material such as NiTinol is deformed while in a martensitic state (low yield strength condition) and then heated to its transition temperature to reach an austenitic state, the SMA material will resume its austenitic shape. The rate of return to the austenitic shape depends upon the amount and rate of thermal energy applied to the component.

When cooled to its martensitic temperature, the SMA material can be made to return to its martensitic shape usually with an externally applied force, for example, from a return spring or other return apparatus. Exemplary return springs used in conjunction with SMA rotary actuators are disclosed in U.S. Pat. No. 6,065,934 to Jacot et al., titled “Shape Memory Rotary Actuator”; and U.S. Pat. No. 6,499,952 to Jacot et al., titled “Shape Memory Alloy Device and Control Method.” The entire disclosures of U.S. Pat. Nos. 6,065,934 and 6,499,952 are each incorporated herein by reference as if fully set forth herein.

SMA materials have been used in actuators to provide one-way actuation in which the SMA material is heated to transition to its austenitic shape, thereby generating actuation forces. For example, one-way SMA actuators have been used in spacecraft deployment operations to deploy (but not stow) instrumentation payloads or other appendages. In such “one-shot” deployment operations, the SMA material is heated to transition to its austenitic state and to thus produce actuation force for deploying or moving a device from a stowed positioned to a deployed position usually after the spacecraft has reached a selected orbit or other extraterrestrial location. Upon cooling, however, the SMA material's austenite-to-martensite transition usually does not generate sufficient actuation forces to enable the one-way actuator to perform significant work, such as closing a door or stowing the spacecraft instrumentation payloads, etc.

Indeed, the two-way shape memory effect in SMA materials has historically been considered unreliable, inconsistent, and incapable of performing significant work, particularly during the austenite-to-martensite transition. Further, existing methods to produce two-way SMA parts (e.g., SMA parts capable of performing significant work during both the austenite-to-martensite transition and the martensite-to-austenite transition) are relatively complex, cumbersome, and not readily translatable to a production environment.

### SUMMARY

The present invention relates to methods of making two-way shape memory alloy (SMA) parts and to devices including two-way SMA parts, such as a hinge apparatus that includes a two-way controllable hinge pin actuator formed from a two-way SMA. In a preferred implementation, a method generally includes thermal cycling a material under a sufficient load for a sufficient number of thermal cycles (e.g., about one thousand or more thermal cycles, etc.) between about the material's austenite and martensite temperatures to complete training of the material. The thermal cycling conditions the material to transition, without an externally applied load, between an austenitic shape and a martensitic shape to perform useful work when the material is thermally cycled between the austenite and martensite temperatures.

In another preferred implementation, a hinge apparatus generally includes a hinge pin formed of a two-way shape memory alloy (SMA) adapted to transition, without an externally applied load, between a first trained shape and a second trained shape upon switching the two-way SMA between a first state and a second state. The hinge pin can apply two-way reversible actuation forces (e.g., an opening force and a closing force, etc.) to a device (e.g., door, etc.) coupled to the hinge apparatus.

In another preferred implementation, the invention provides a method in which only one shape memory alloy (SMA) can be used to effect motion in a first and a second direction of a device coupled to a hinge apparatus. The hinge apparatus includes a hinge pin formed of a two-way SMA. The method generally includes moving the device in the first direction by switching the two-way SMA from a first state in which the hinge pin is in a first trained shape to a second state in which the hinge pin is in a second trained shape. The method can also include moving the device in the second or opposite direction by switching the two-way SMA from the second state to the first state.

The features, functions, and advantages can be achieved independently in various embodiments of the present inventions or may be combined in yet other embodiments.

### BRIEF DESCRIPTION OF THE DRAWINGS

The present invention will become more fully understood from the detailed description and the accompanying drawings, wherein:

FIG. 1 is an exploded perspective view of a hinge apparatus including a hinge pin formed from a two-way shape memory alloy (SMA) according to a preferred embodiment of the invention;

FIG. 2 is a partial perspective view of the hinge apparatus shown in FIG. 1 after being assembled;

FIG. 3 is a perspective view of the hinge apparatus shown in FIG. 1 being used to controllably position an exemplary instrument cover;

FIG. 4 is an exemplary line graph illustrating displacement versus pin length for various hinge pin configurations in accordance with the principles of the invention;

FIG. 5 is an exemplary line graph illustrating torque versus pin outer diameter for various hinge pin configurations in accordance with the principles of the invention;

FIG. 6 is an exemplary line graph illustrating martensite and austenite shear strain as a function of thermal cycles for a two-way SMA torque tube in accordance with the principles of the invention;

FIG. 7 is an exemplary line graph illustrating martensite and austenite shear strain as a function of thermal cycles for a two-way SMA torque tube initially placed under a generally uniform iso-force load and then, after about three thousand thermal cycles, is placed under a spring load to illustrate stability of the torque tube strain under the spring loading in accordance with the principles of the invention;

FIG. 8 is an exemplary line graph illustrating no-load dynamic shear strain as a function of thermal cycles for a two-way SMA torque tube with no applied load in accordance with the principles of the invention, wherein the dynamic shear strain is defined as the difference between the tube's shear strain in the fully martensite condition and the tube's shear strain in the fully austenite condition; and

FIG. 9 is an exemplary line graph illustrating dynamic shear strain as a function of applied shear stress for a two-way SMA torque tube in accordance with the principles of the invention.

### DETAILED DESCRIPTION OF THE PREFERRED EMBODIMENTS

The following description of the preferred embodiments are merely exemplary in nature and is in no way intended to limit the invention, its application, or uses.

According to one aspect, the invention provides methods for making two-way shape memory alloy (SMA) parts (e.g., torque tubes, hinge pins, etc.). In a preferred implementation, a method generally includes thermal cycling a material under a sufficient load for a sufficient number of thermal cycles (e.g., about one thousand or more thermal cycles, etc.) between the material's austenite and martensite temperatures to complete the training of the material. This thermal cycling conditions the material to transition, without an externally applied load, between an austenitic shape and a martensitic shape to perform useful work when the material is thermally cycled between the austenite and martensite temperatures.

Accordingly, various implementations of the invention can produce stable, robust, and predictable two-way SMA parts that are capable of performing useful and significant work over numerous (e.g., thousands) thermal cycles during both the austenite-to-martensite transition and the martensite-to-austenite transition. Such parts can include two-way shape memory effects that enable reversible actuation without requiring any additional devices or mechanisms (e.g., return spring, etc.) to produce the reverse actuation.

Another aspect of the invention includes a two-way controllable hinge apparatus. The hinge apparatus includes a hinge pin formed from a two-way SMA. The hinge pin can apply two-way reversible actuation forces (e.g., an opening force and a closing force, etc.) to a device (e.g., door, etc.) coupled to the hinge apparatus. This two-way reversible actuation also enables intermediate positioning of the hinge apparatus in positions less than fully open or closed by appropriately adjusting the temperature of the hinge pin. Accordingly, this integrated hinge pin actuator can provide both the structural and actuation requirements for controllably positioning a device (e.g., doors, aircraft control surfaces, etc.) coupled to the hinge apparatus.

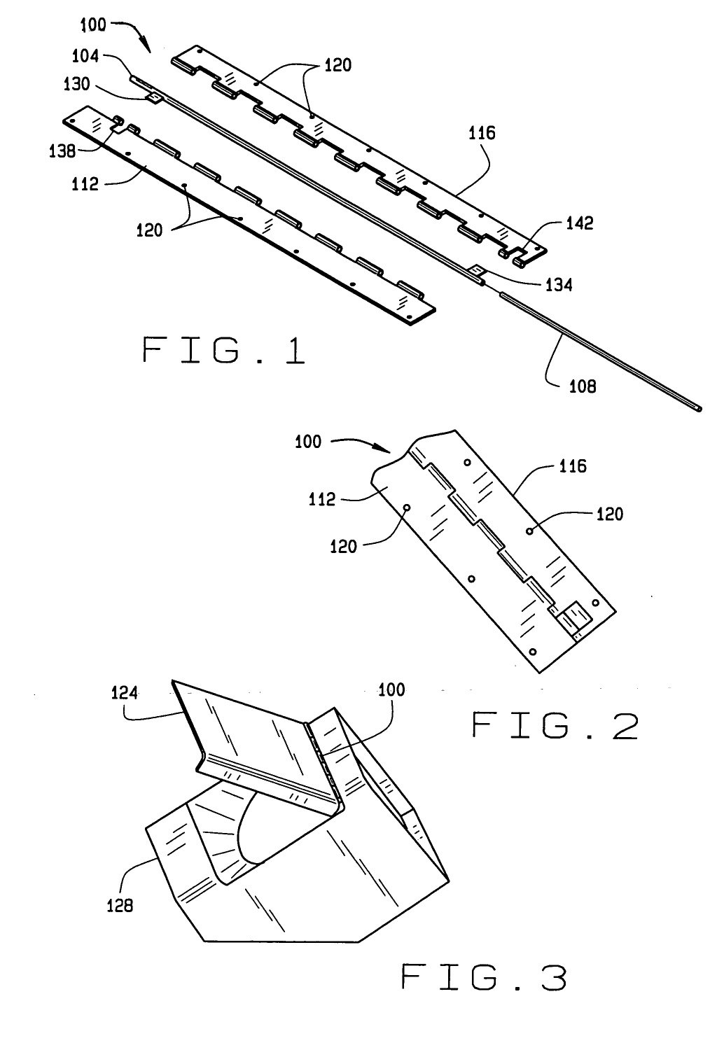

FIGS. 1 through 3 illustrate an exemplary hinge apparatus 100 in accordance with the principles of this invention. As shown, the hinge apparatus 100 includes a hinge pin 104 and a device 108 to cause the hinge pin 104 to heat. The hinge pin 104 is coupled to generally opposed leaf panels 112 and 116. Alternatively, the hinge pin 104 can be attached to opposing sides of surrounding structure, among other possibilities.

Each leaf 112 and 116 can include a plurality of openings or holes 120. These holes 120 can be sized to receive suitable fasteners therethrough for attaching the hinge apparatus 100 to surrounding structure.

In various embodiments, the leaf panels 112 and 116 and hinge pin 104 can be shaped and sized so as to be substantially similar in size and shape to the respective leaf panels and connecting pin of a conventional mechanical hinge. By doing so, the hinge apparatus 100 could be retrofit into various applications that presently include conventional mechanical hinges.

To enable two-way reversible actuation, the hinge pin 104 is fabricated from a two-way SMA adapted to transition, without an externally applied load, between a first trained shape and a second trained shape when the two-way SMA is thermally cycled between a first temperature and a second temperature to switch the two-way SMA between a first state to a second state.

In an exemplary embodiment, the first state is an austenitic state of the two-way SMA, and the second state is a martensitic state of the two-way SMA. When thermally activated or heated, the two-way SMA begins to enter the austenitic state at its austenite start temperature (temperature at which the transformation from martensite to austenite begins on heating). During this martensite-to-austenite transformation, the hinge pin 104 rotates or twists in a first rotational direction towards the first trained or austenitic shape. With continued heating, the two-way SMA eventually completes the martensite-to-austenite transformation at its austenite finish temperature (temperature at which the transformation from martensite to austenite finishes on heating). It should be understood that the austenite start and finish temperatures and rate of the martensite-to-austenite transformation can vary depending on the particular application and its thermal environment, the composition of and particular SMA materials being used, and/or amount and rate of thermal energy applied to the hinge pin 104.

In a preferred embodiment, the martensite-to-austenite transformation includes the hinge pin 104 rotating into a twisted configuration such that the austenitic shape corresponds to a twisted configuration of the hinge pin 104. Alternatively, the martensite-to-austenite transformation can include the hinge pin 104 rotating into an untwisted configuration in which case the austenitic shape would correspond to an untwisted configuration of the hinge pin 104.

Upon cooling, the two-way SMA begins to enter a martensitic state at its martensite start temperature (temperature at which the transformation from austenite to martensite begins on cooling). During this austenite-to-martensite transformation, the hinge pin 104 rotates in a second rotational direction (counter-rotates) towards the second trained or martensitic shape. With continued cooling, the two-way SMA eventually completes the austenite-to-martensite transformation at its martensite finish temperature (temperature at which the transformation from austenite to martensite finishes on cooling). It should be understood that the martensite start and finish temperatures and rate of the austenite-to-martensite transformation can vary depending on the particular application and its thermal environment, the composition of and particular SMA materials being used, and/or amount and rate of cooling or heat transfer from the hinge pin 104.

In a preferred embodiment, the austenite-to-martensite transformation includes the hinge pin 104 rotating into an untwisted configuration such that the martensitic shape corresponds to an untwisted configuration of the hinge pin 104. Alternatively, the austenite-to-martensite transformation can include the hinge pin 104 rotating into a twisted configuration in which case the martensitic shape would correspond to the twisted configuration of the hinge pin 104.

Cooling the two-way SMA can include passive cooling, active cooling, a combination thereof, etc. In an exemplary embodiment, the two-way SMA is passively cooled through heat exchange with its surrounding environment (e.g., structure, ambient atmosphere, etc.) once the heating device 108 is deactivated or switched off. Alternatively, or additionally, the two-way SMA can be actively cooled, for example, if a higher rate of transformation to the martensitic state and shape is desired. By way of example, the two-way SMA can be actively cooled by circulating coolant over the hinge apparatus 100.

By way of further example, the two-way SMA can be actively cooled by using thermoelectric devices, wherein instead of relying upon heat flow (a temperature gradient between materials or areas), to generate a voltage in a thermocouple mode for the thermoelectric devices, power is supplied to the thermoelectric device(s) to cause heat to flow from one side of the device to the other side. The efficiency (i.e., the Coefficient of Performance or COP) of a thermoelectric device can be roughly categorized by the heat flow divided by the input power. Where large thermal gradients naturally exist, little additional electric power need be supplied to a thermoelectric device to maintain it in the cooling mode, as is understood with the Seebeck effect. Advanced thermoelectric devices and their performance including discussion of the Peltier effect and Seebeck effect is provided in U.S. Pat. No. 6,100,463, which we incorporate by reference. Thermoelectric devices suitable for use in an embodiment of the present application are commercially available from MELCOR (Materials Electronic Products Corp.) and other sources. Devices providing high COP are preferred.

By way of example only, the hinge pin 104 can be formed from a two-way SMA torque tube made in accordance with methods described below. Alternatively, other shapes and methods can be employed for the hinge pin 104 depending on the particular application in which the hinge apparatus 100 will be employed.

The hinge pin 104 can also be provided in various sizes depending at least in part on the particular application in which the hinge apparatus 100 will be employed. Although the hinge pin 104 is configurable for a wide range of force and displacement applications, exemplary dimensions (i.e., length, outer and inner diameters, and tube wall thickness) for four different hinge pin sizes and displacement and torque associated therewith are set forth below for purposes of illustration only.

| | OUTER | INNER | WALL | | |
|---|---|---|---|---|---|
| LENGTH | DIAMETER | DIAMETER | THICKNESS | DISPLACEMENT | TORQUE |
| (inches) | (inches) | (inches) | (inches) | (degrees) | (inch * pounds) |
| 6 | 0.25 | 0.2 | 0.025 | 96 | 27 |
| 12 | 0.25 | 0.2 | 0.025 | 192 | 27 |
| 12 | 1 | 0.9 | 0.05 | 48 | 1010 |
| 24 | 1 | 0.8 | 0.1 | 96 | 1740 |

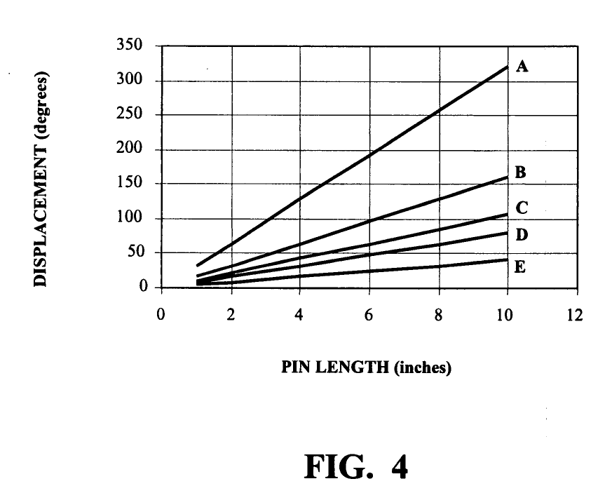

FIG. 4 is an exemplary line graph illustrating displacement versus pin length for five different hinge pin configurations A, B, C, D, and E having respective inner and outer diameters and wall thickness as set forth in the table below.

| | OUTER | INNER | WALL |
|---|---|---|---|
| | DIAMETER | DIAMETER | THICKNESS |
| CONFIGURATION | (inches) | (inches) | (inches) |
| A | 0.125 | 0.1 | 0.0125 |
| B | 0.25 | 0.2 | 0.025 |
| C | 0.375 | 0.3 | 0.0375 |
| D | 0.5 | 0.4 | 0.05 |
| E | 1 | 0.8 | 0.1 |

FIG. 4 generally shows that increasing pin length increases displacement, whereas decreasing pin outer diameter decreases displacement. It should be noted, however, that the dimensions, data, and values in FIG. 4 are for illustrative purposes only and not for purposes of limitations.

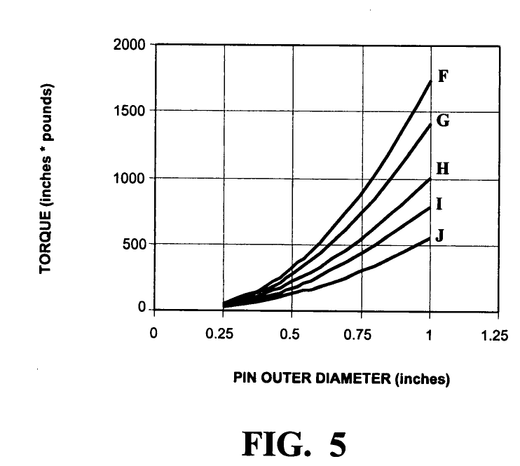

FIG. 5 is an exemplary line graph illustrating torque versus pin outer diameter for five different hinge pin configurations F, G, H, I, and J having respective wall thicknesses of 0.1 inches, 0.075 inches, 0.05 inches, 0.0375 inches, and 0.025 inches. FIG. 5 generally shows that increasing pin outer diameter increases torque, but decreasing wall thickness decreases torque. It should be noted, however, that the dimensions, data, and values in FIG. 5 are for illustrative purposes only and not for purposes of limitations.

With further reference to FIG. 1, the hinge apparatus 100 also includes the device 108 to thermally activate or cause the hinge pin 104 to heat and switch the two-way SMA between states. In an exemplary embodiment, the device 108 includes a heating element, especially a thermoelectric heating device, directly attached to the hinge pin 104. Another example includes the hinge pin 104 being heated by non-contact inductive heating and/or by passive environmental heating. By way of further example, the device 108 can include a heating element disclosed in U.S. Pat. No. 6,065,934 to Jacot et al., titled “Shape Memory Rotary Actuator”; and U.S. Pat. No. 6,499,952 to Jacot et al., titled “Shape Memory Alloy Device and Control Method.” The entire disclosures of U.S. Pat. Nos. 6,065,934 and 6,499,952 are each incorporated herein by reference as if fully set forth herein.

Alternatively, a wide range of other suitable devices and methods can be employed to cause the hinge pin 104 to heat and switch the two-way SMA between states. The particular device and/or method used can depend, at least in part, on weight and space requirements and preferred rate of the martensite-to-austenite transformation.

The hinge apparatus 100 can thus apply reversible actuation forces to a device or object coupled to the hinge apparatus 100 in a first direction or a second direction depending on whether the hinge pin 104 is being heated or cooled. This two-way reversible actuation also enables intermediate positioning of the device in positions less than fully open or closed by appropriately adjusting the temperature of the two-way SMA between its austenite and martensite temperatures.

FIG. 3 illustrates the hinge apparatus 100 coupled to an exemplary instrument cover or door 124. The hinge apparatus 100 can be used to controllably position (open, close, partially open or close, etc.) the door 124 relative to the supporting structure 128, which in the illustrated embodiment is a instrument chassis or housing.

During operation, the hinge pin 104 can be heated to cause the two-way SMA to enter its austenitic state. This transformation to the austenitic state causes the hinge pin 104 to rotate or twist in a first rotational direction towards the austenitic shape. The rotating hinge pin 104 applies a force for rotating the door 124 in the first rotational direction, which can be either a closing motion or opening motion depending on the particular configuration. In a preferred embodiment, the hinge pin 104 can apply an opening force to the door 124 upon switching the two-way SMA to its austenitic state. Alternatively, the hinge pin 104 can apply a closing force to the door 124 upon switching the two-way SMA to its austenitic state.

To controllably move the door 124 in an opposite or second rotational direction, the two-way SMA can be cooled to cause the two-way SMA to enter the martensitic state. During this cooling, the hinge pin 104 rotates in the second rotational direction towards the martensitic shape. The rotating hinge pin 104 applies a force for rotating the door 124 in the second rotational direction, which can be either a closing motion or an opening motion depending on the particular configuration. In a preferred embodiment, the hinge pin 104 can apply a closing force to the door 124 upon switching the two-way SMA to its martensitic state. Alternatively, the hinge pin 104 can apply an opening force to the door 124 upon switching the two-way SMA to its martensitic state.

Depending on particular circumstances, it may be advantageous to controllably move the door 124 into an intermediate position in which the door 124 is only partially opened/closed. This can be accomplished by adjusting and/or maintaining a bulk material temperature of the two-way SMA between its austenite and martensite temperatures. Alternatively, the two-way SMA can be maintained held at an intermediate position by controlling the temperature at a specific location of the two-way SMA between its austenite and martensite temperatures.

Accordingly, a hinge apparatus including a hinge pin actuator formed of a two-way SMA can provide both the structural and actuation requirements to controllably position a device coupled to the hinge apparatus, such as bay doors, instrument covers, access panels, aircraft control surfaces, among others. This integration of the structural and actuation requirements into the hinge pin can eliminate the need for an additional actuator and its associated mechanisms, thereby conserving space and reducing weight and overall system complexity.

Further, various implementations of the invention can also provide two-way electrically controllable actuators having a high energy density that are configurable over a wide range of forces and displacements and that possess nearly the energy density of a traditional hydraulic actuator. Many applications are possible for a two-way electrically controllable hinge apparatus in accordance with the principles of the invention. In the aerospace area, exemplary applications for a two-way electrically controllable hinge apparatus include control surface actuation, thrust vector control, and actuation of landing gear, especially in cold weather or at high altitudes. In industrial areas, a two-way electrically controllable hinge apparatus can be suitable for lifting, positioning, holding, or moving devices and objects, especially in cold temperatures where hydraulics have problems. A myriad of applications for automobiles and farm equipment that use hydraulic systems today could be converted to electrical actuation.

A hinge apparatus in accordance with the principles of the invention can be applied in any implementation where a hinge apparatus including a reversible hinge pin actuator would be advantageous regardless of whether the hinge apparatus is associated with a mobile platform (e.g., aircraft, ship, boat, train, automobile, etc.) or a fixed or non-mobile platform (e.g., house, etc.). Accordingly, the specific references herein to aircraft, spacecraft, and doors should not be construed as limiting the scope of the present invention to only one specific form/type of application.

In another form, the invention provides methods of making two-way SMA parts. By way of example only, these methods can be used to produce two-way SMA torque tubes or hinge pins, such as the hinge pin 104. It is to be understood, however, that the methods described herein can also be employed to make a wide range of other two-way SMA parts in various sizes and shapes and for various applications.

A preferred implementation of a method for making a two-way SMA part will now be described. Initially, a suitable material can be selected for the part, such as a NiTinol material having about 20% to 30% cold work. Suitable NiTinol materials are commercially available from Special Metals of New Hartford, N.Y., Metaltex International of Reno, Nev., and Wah Chang of Albany, Oreg. Alternatively, other suitable materials can be used depending, at least in part, on the particular application in which the part will be used.

Now that a suitable material has been selected, that material can be shaped or formed into a desired bulk shape. The desired shape can vary depending on the intended use for the finished part. For example, the selected material can be formed into a generally cylindrical shape if the finished part will be a torque tube.

Exemplary processes by which the material may be fashioned into the desired bulk shape include electro discharge machining (EDM), grinding, and machining with carbide-cutting tools. Alternatively, other exemplary processes can also be employed depending, at least in part, on the particular shape into which the material is to be formed.

Next, a heat treating operation can be performed on the fashioned part, i.e., the selected material having the bulk shape. The heat treating sets the austenitic shape and initiates shape memory effect in the material forming the fashioned part.

The heat treating can occur while maintaining the part in the desired bulk shape to establish the desired bulk shape as the austenitic shape. By way of example, the fashioned part can be secured in a fixture or structure. The fixture holds and maintains the fashioned part in the desired bulk shape during the heat treatment. While in the fixture, the fashioned part can be heated (e.g., in a circulating air furnace, etc.) to a temperature within a range of about 375 degrees Celsius and about 475 degrees Celsius. The heated part can then be held at temperature for about five minutes, and water quenched. It should be understood, however, that the specific temperature ranges, time periods, and liquid(s) in which the part is quenched can vary depending at least in part on the particular materials being used and/or parts being produced.

The heat treated part can then be thermal cycled under an externally applied load. This thermal cycling continues for a sufficient number of thermal cycles at least until the part is capable of transitioning between its austenitic and martensitic shapes, without requiring an externally applied load to the part, when the part is thermally cycled between its austenite and martensite temperatures. Upon completion of the thermal cycling, the part is capable of performing useful work over numerous thermal cycles during both the martensite-to-austenite transition and the austenite-to-martensite transition.

By way of example only, the thermal cycling can include placing the heat treated part in a training fixture. The training fixture applies a generally uniform iso-force load to the part to cause the part to strain away from its austenitic shape towards its martensitic shape. In an exemplary implementation, the training fixture places on the part a generally constant stress of about fifty percent (50%) more than the expected working stress of the finished part.

While the training fixture is applying the load to the part, the part can be thermally cycled for about one thousand cycles or more between its austenite finish temperature (the temperature at which the transition from martensite to austenite finishes on heating) and its martensite finish temperature (the temperature at which the transformation from austenite to martensite finishes on cooling). It should be understood, however, that the specific loads and stresses applied to the part during the thermal cycling, particular number of thermal cycles performed, particular temperature ranges between which the part is thermal cycled, and austenite and martensite start and finish temperatures can vary depending on the particular materials being used and/or parts being produced.

It should be noted that various implementations of the invention can include training a shape memory alloy (SMA) that has already been formed into a desired shape and that has already been heat treated to set the austenitic shape and initiate shape memory effect in the SMA. Accordingly, these implementations need not include the shaping and heat treating operations described above. To complete the training of the SMA, however, such implementations can include thermal cycling the SMA under a sufficient load for a sufficient number of thermal cycles (e.g., about one thousand or more thermal cycles, etc.) between about the SMA's austenite and martensite temperatures. This thermal cycling conditions the SMA to transition, without an externally applied load, between an austenitic shape and a martensitic shape while performing useful work when the SMA is thermally cycled between its austenite and martensite temperatures.

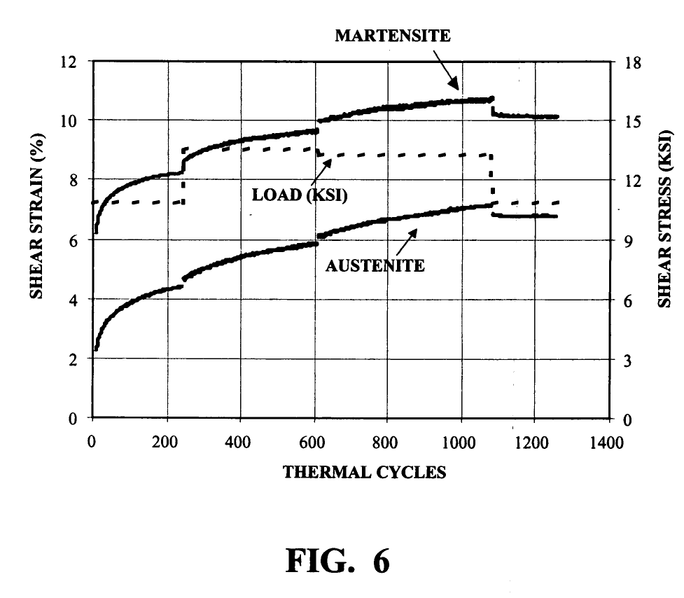

FIGS. 6 through 9 generally show exemplary data obtained while testing performance of a two-way SMA torque tube made in accordance with a method of the present invention. As described below, this test data validates robustness and consistency of the torque tube's two-way performance over thousands of thermal cycles. It should be noted, however, that the test data and values in FIGS. 6 through 9 are for illustrative purposes only and not for purposes of limitations.

More specifically, FIG. 6 is an exemplary line graph illustrating martensite and austenite shear strain as a function of thermal cycles for a two-way SMA torque tube. As shown, the torque tube initially undergoes relatively significant plastic deformation that begins to decrease as the cycle count increases. The plastic deformation can be predicted and should be taken into account when designing the initial SMA part dimensions so that the final trained dimensions meet the design. After about one thousand thermal cycles, a reduction in load to working levels results in a near elimination of deformation creep. The stability of the torque tube's two-way performance is apparent when the load is reduced after one thousand cycles.

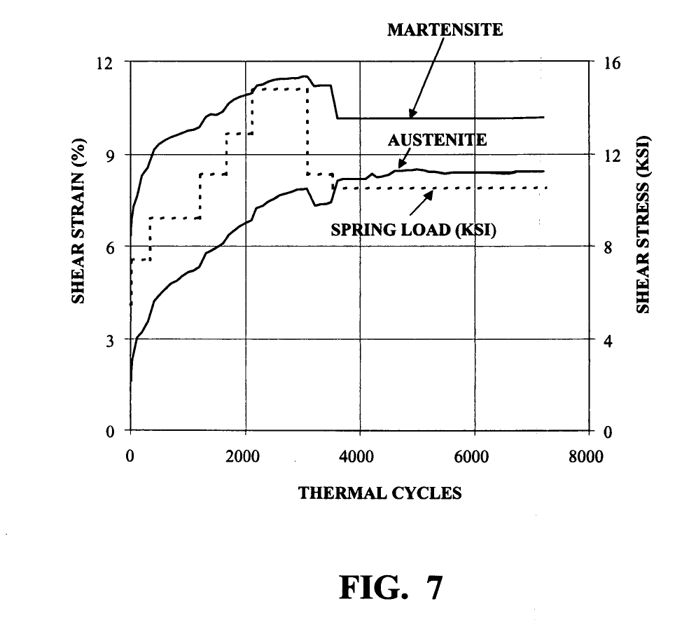

FIG. 7 is an exemplary line graph illustrating martensite and austenite shear strain as a function of thermal cycles for a two-way SMA torque tube initially placed under a generally uniform iso-force load and then, after about three thousand thermal cycles, is placed under a spring load. To simulate an actuator with an average load of 10.5 KSI (thousands of pounds per square inch), the spring load had a pre-stress in the martensite condition of nearly zero and a peak stress in the austenite condition of 21 KSI. The torque tube strain (both austenite and martensite) was relatively stable for several thousand thermal cycles with an applied average spring load of 10.5 KSI. The torque tube operated for more than three thousand cycles with little or no creep and consistent 2-way displacement. The relatively strong two-way shape memory effect of the torque tube allowed spring operation without any preloading. Other tests have verified that similar results can be achieved with only about one thousand thermal conditioning cycles.

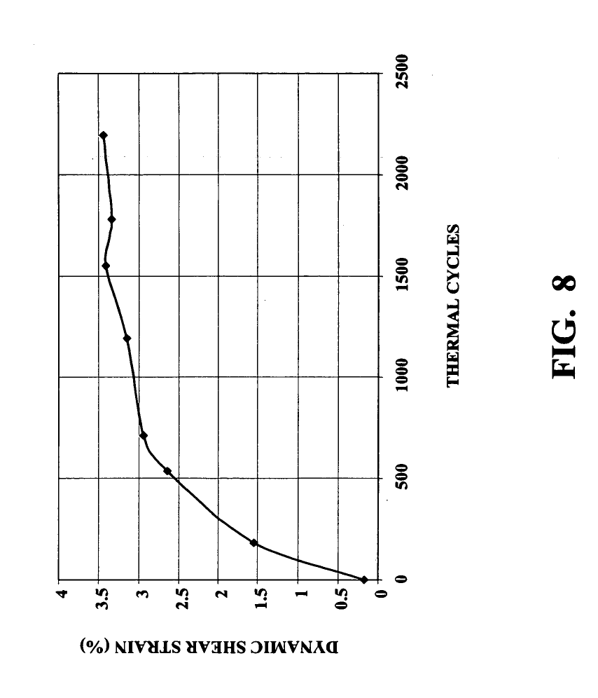

FIG. 8 is an exemplary line graph illustrating no-load dynamic shear strain as a function of thermal cycles for a two-way SMA torque tube with no applied load. Dynamic shear strain is defined as the difference between the tube's shear strain in the fully martensite condition and the tube's shear strain in the fully austenite condition. FIG. 8 generally shows the torque tube's level of two-way performance as measured by periodically thermally cycling the torque tube with no applied load and measuring the displacement/strain of the tube as the tube is undergoing training and conditioning.

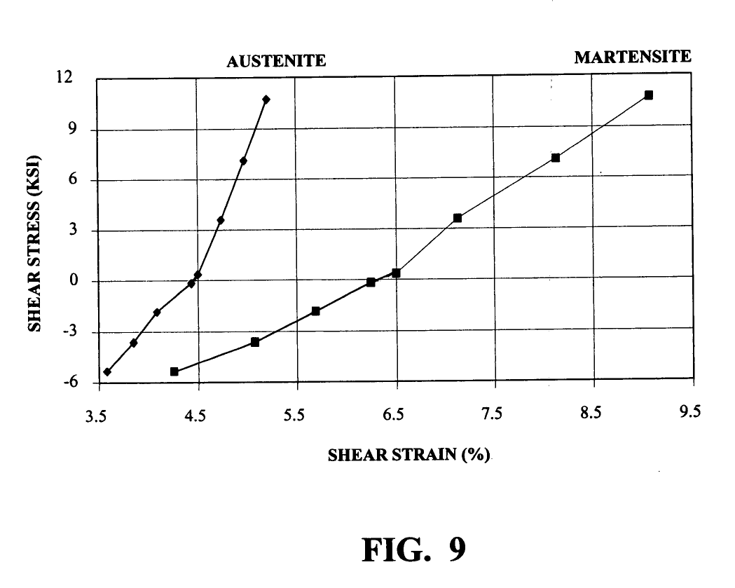

FIG. 9 is an exemplary line graph illustrating two-way dynamic shear strain as a function of applied shear stress for a two-way SMA torque tube. FIG. 9 generally shows the ability of the two-way shape memory effect to perform real work, which is indicated when the shear stress become negative or goes below zero. As shown, the torque tube can perform useful work during both its austenite-to-martensite transition and its martensite-to-austenite transition.

Accordingly, various implementations of the invention include methods that can be used to train two-way shape memory effects into a wide range of materials, including commercially available SMA materials, like NiTinol. Such methods can be readily translated into a production environment to yield predictable, cost-effective, stable, robust, and two-way controllable SMA parts that are capable of performing useful work over numerous thermal cycles during both the martensite-to-austenite transition and the austenite-to-martensite transition.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

1-34. (canceled)

35. A piano hinge defining a hinge line, the piano hinge comprising a two-way shape memory alloy (SMA) positioned along the hinge line to form a pin that at least partially twists when the two-way SMA pin changes between an austenite temperature and a martensite temperature, hinge leafs defining a passage into which the two-way SMA pin fits, and a key-spline arrangement rigidly securing the two-way SMA pin to the hinge leafs for transfer of torque from the two-way SMA pin to one of the hinge leafs relative to the other of said hinge leafs.

36. The piano hinge of claim 35, wherein the hinge leafs include alignable knuckles that define the passage into which the two-way SMA pin fits.

37. The piano hinge of claim 35, wherein the two-way SMA is configured to apply torque within a range of about 27 inch pounds and about 1740 inch pounds.

38. The piano hinge of claim 35, wherein the two-way SMA is configured to apply torque within a range of about 27 inch pounds and about 1010 inch pounds.

39. The piano hinge of claim 35, wherein the two-way SMA is configured to apply torque within a range of about 1010 inch pounds and 1740 inch pounds.

40. The piano hinge of claim 35, wherein the two-way SMA is configured to apply torque at about 1740 inch pounds.

41. A piano hinge comprising first and second hinge leafs having alignable knuckles that define a passage into which a hinge pin fits, a two-way shape memory alloy (SMA) hinge pin at least partially disposed within the passage defined by the knuckles, the two-way SMA hinge pin having at least a first tab rigidly secured to the first hinge leaf and at least a second tab rigidly secured to the second hinge leaf, wherein the two-way SMA hinge pin at least partially twists when the two-way SMA pin changes between an austenite temperature and a martensite temperature, such that torque from the two-way SMA pin is transferred to one of the hinge leafs relative to the other of said hinge leafs.

42. The piano hinge of claim 41, wherein the first tab is at one end portion of the two-way SMA hinge pin and the second tab is at the other end portion of the two-way SMA hinge pin, such that the partial twisting of the hinge pin applies a torque to the first tab relative to the second tab.

43. The piano hinge of claim 42, wherein the hinge pin rotates into an intermediate partially twisted configuration when a temperature of the two-way SMA is between the austenite temperature and the martensite temperature.

44. The piano hinge of claim 43, wherein the two-way SMA is configured to apply torque within a range of about 27 inch pounds and about 1740 inch pounds.

45. The hinge apparatus of claim 43, further comprising a device to cause the hinge pin to heat and switch the two-way SMA between at a first trained shape and a second trained shape.
